(19) United States
(12) Patent Application Publication
(10) Pub. No.: US 2007/0244416 A1
(43) Pub. Date: Oct. 18, 2007

(54) MASSAGER WITH DIGITAL AUDIO PLAYER AND METHOD

(76) Inventors: Benson Sobin, Monrovia, CA (US); Stuart B. Long, Woodland Hills, CA (US)

Correspondence Address: ITALIA IP, 3500 WEST OLIVE AVE., SUITE 300, BURBANK, CA, 91505, US

(21) Appl. No.: 11/279,751

(22) Filed: Apr. 14, 2006

(51) Int. Cl. A61H 1/00

(52) U.S. Cl. 601/46; 601/47

(57) ABSTRACT

A massager with digital audio playing capabilities such that the user can connect the massager to a computer through a suitable connection and transfer digital audio files to the massager for storage and playback by the user.

### SUMMARY

A massager with digital audio player including an upper body, a lower body, wherein the lower body includes a digital audio player comprising a controller for controlling said digital audio player, external connecting means for connecting said massager to a computer such that digital audio files can be transferred to said massager, storage means for storing said digital audio files transferred to said massager, decoding means to convert said digital files to analog files, operator means for responding to operator commands; and audio output means to output the analog audio signals.

In another embodiment, the application discloses a massager with digital audio player including an upper body, a lower body, wherein said lower body includes a digital audio player comprising a controller for controlling said digital audio player, external connecting means for connecting said massager to a computer such that digital audio files can be transferred to said massager, storage means for storing said digital audio files transferred to said massager, decoding means to convert said digital files to analog files; and, a remote comprising operator means for responding to operator commands; and audio output means to output the analog audio signals.

Finally, the application discloses a method of using a massager with digital audio player capabilities including connecting one of the massagers described above to a computer using an external connector, transferring the selected digital audio files to memory located in said massager, storing the selected digital audio files in memory located in said massager, converting the digital audio files to analog files, outputting the analog files to audio output means so that the user can hear the selected audio files; and, controlling the operation of the massager and audio files selected.

### BRIEF DESCRIPTION OF THE DRAWINGS

The drawings, when considered in connection with the following description, are presented for the purpose of facilitating an understanding of the subject matter sought to be protected.

FIG. 1 is a perspective view of a first embodiment of the massager;

FIG. 2 is a perspective view of a second embodiment of the massager;

FIG. 3 is a functional block diagram of the digital media player portion of the massager;

FIG. 4 is a first embodiment of a diagram showing exemplary downloading of MP3 digital audio bit stream media from an MP3 digital audio bit stream source available on the Internet.

FIG. 5 is a first embodiment of a diagram showing exemplary downloading of MP3 digital audio bit stream media from an MP3 digital audio bit stream source available on the Internet.

FIG. 6A is a perspective view of a variation of the massager shown with a sheath fit upon the massager; and, FIG. 6B is a perspective cross-sectional view along the line 6B-6B of the sheath shown in FIG. 6A.

### DETAILED DESCRIPTION OF THE EMBODIMENTS

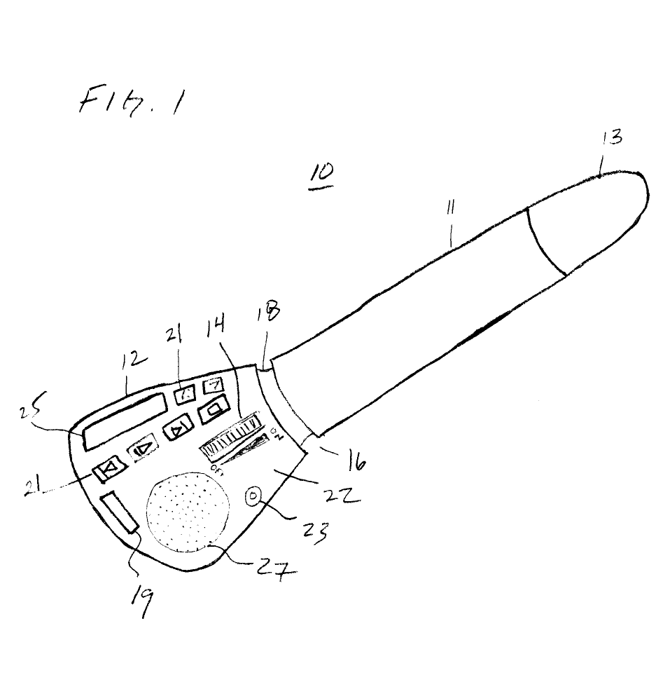

Referring to FIG. 1, the massager with digital audio player 10 includes an upper body 11 which may have a probe-like configuration and a lower body 12. The massager 10 is made of either a rigid or semi-rigid material or a combination of both. For example, with the rigid massager, material such as hard plastic or any other similar rigid material can be used. In the case of a semi-rigid massager, material such as rubber or any other similar semi-rigid material can be used. Regardless of the material used, massager 10 should withstand wet or moist environments as well as being electrically safe and secure without delivering a risk of shock to the user.

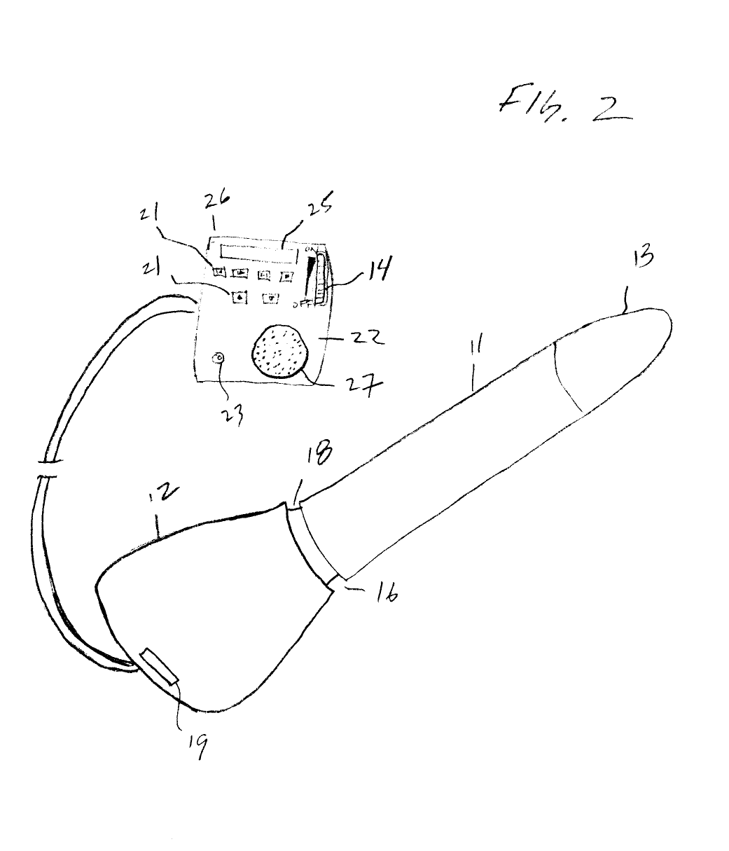

As shown in FIGS. 1 and 2, the distal end 13 of the upper body 11 is rounded with the sides of the upper body 11 being generally cylindrical and straight. The upper body 11 may be hollow and may incorporate, as is conventional in the art, an oscillating or eccentric motor (not shown) or the like to provide vibration when the massager 10 is switched on. Alternatively, the massager 10 may not have any vibratory or osculation mechanism. Additionally, the hollow nature of the upper body 11 may provide room for batteries (not shown) or the like so that power may be supplied to the massager 10. The base 16 of the upper body 11 includes a circumferential groove 18.

Referring now to FIG. 1, according to one embodiment of the massager, the lower body 12 has a generally round shape and includes the various functions of the massager, or, as shown in FIG. 2, on a separate wired or wireless remote 26, including a speed control apparatus 14 that allows the user to rotate the apparatus 14 to not only power on the massager 10 but to increase or lessen the degree of its vibration by rotating the speed control apparatus 14 in a up or down direction. Such vibration mechanism and activation are well known in the art.

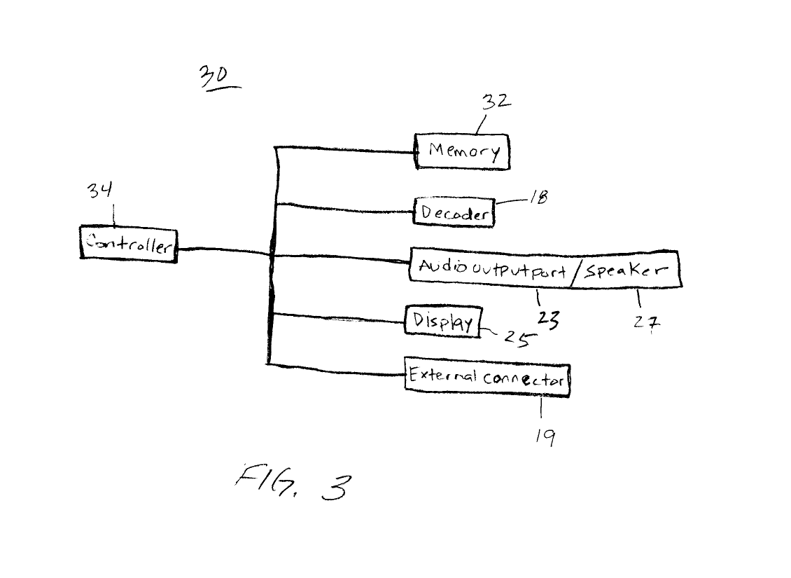

The lower body 12 also includes the various operation buttons 21 that control the digital audio playing portion 30 of the device. Buttons 21 are operatively engaged by the lower body 12 and serve for executing operator commands to a controller 34 (see FIG. 3), such as, but not limited to, play, stop, pause, backward, forward, repeat, repeat a sequence, record, volume control, bass control, treble control, speakers balance and/or fade effects control, etc. As specifically shown in FIG. 1, buttons 21 can be arranged on a front face 22 of lower body 12 or, as shown in FIG. 2, on a separate wired or wireless remote 26. With a wireless remote, a remote control transmitter and a remote control receiver can be employed to execute the above described operator commands (not shown). Any remote communication mode can be employed to remote control the massager 10, such as, but not limited to, infrared, radio, microwave, sound frequency and the like, all as well known in the art of remote controls.

Further, the lower body 12 of the massager 10, or, as shown in FIG. 2, on a separate wired or wireless remote 26, includes a display 25 for indicating an operating state of the massager 10 to a user. For instance, the title of the current track being played can be indicated on the display 25 along with information about the battery life of the massager 10. Audio output means include an audio output port 23 located on the front face 22 of lower body 12, or, as shown in FIG. 2, on a separate wired or wireless remote 26, allows the user to hear the media being played on the massager 10. The audio output port 23 is typically a headphone jack. Alternatively or additionally, the a the lower body 12 of the massager 10, or, as shown in FIG. 2, on a separate wired or wireless remote 26, the audio output means includes a speaker 27 to allow the user to hear the media played without the use of headphones.

FIG. 3 is a functional block diagram of the digital audio playing portion 30 of the massager 10 shown in FIGS. 1 and 2. The digital audio playing portion 30 of the massager is well known in the art. The massager 10 includes in the lower body 12 memory 32 such as a flash memory for storing digital audio files. Audio files in the MP3 format are preferably used in the massager 10 due to their small file sizes, but the massager can also utilize other formats including MP4, WMA, AT&T, a2b, Liquid Audio, Real Audio, SDMI and/or any other existing or developable audio data compressed format. The massager 10 contains an external connector 19 such as a USB connector on the lower body 12 for allowing the massager 10 to connect to a host device such as a computer 44 (FIGS. 1, 2, and 4), but can include other connections existing or developable that allow for the transfer of digital audio files to the massager.

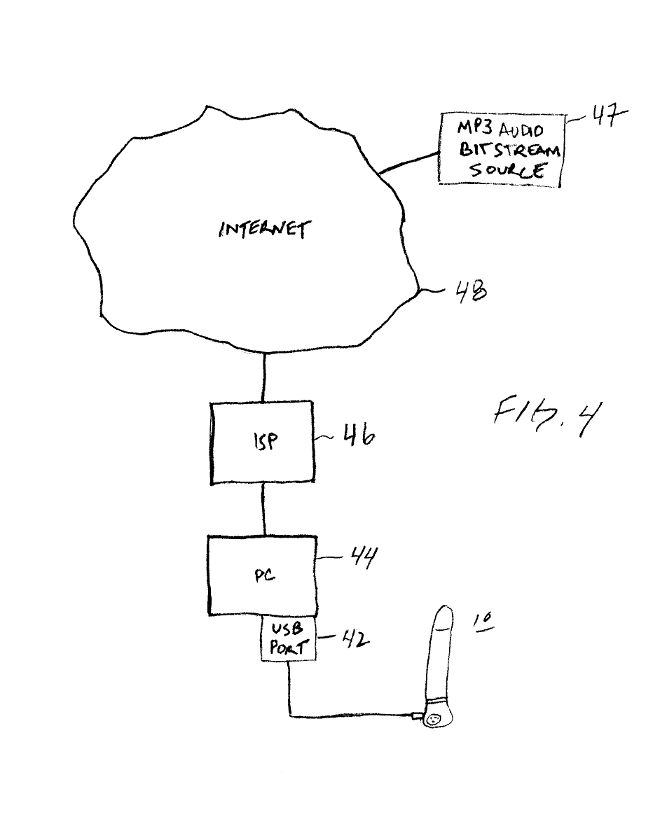

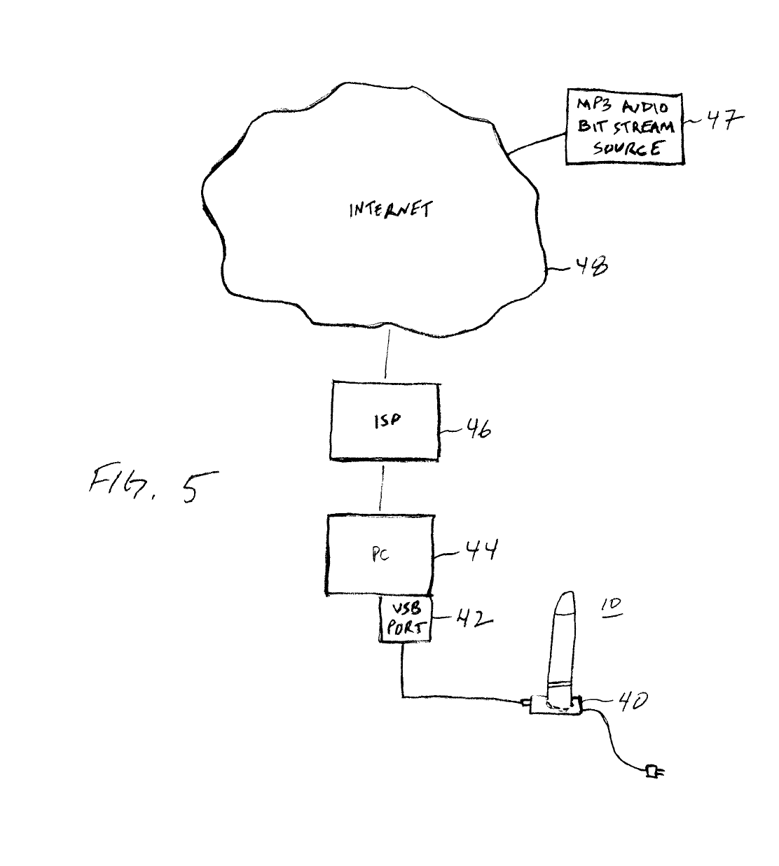

Referring to FIG. 4, the massager 10 connects to the host device's USB port 19 or similar connection for transferring digital audio files from the computer 44 to the massager 10, and vice versa, or, as shown in FIG. 5, through a separate charging stand 40 that connects the massager 10 to the computer 44. The user then can either transfer media files to the massager directly from the computer's memory or the user may connect to the Internet 48 using an Internet Service Provider 46. Once on the Internet, the user can find a MP3 audio bit stream source 47 which interests the user. In a preferred embodiment, the user would go to a website that specializes in, and has available for purchase, audio content that would enhance the user's experience of the massager. For example, the user would be able to purchase the digital audio file (for example a MP3 audio file) and then be able to download the audio file to the massager through the USB port 19. A variety of audio file choices may be available and may include voices of erotic cinema stars, romantic or fantasy themed files, files of different ethnicities and languages, and any other such files desired by the user. Alternatively or additionally, the user could purchase compact discs or any other storage media that is able to contain the desired digital audio files, insert them into to the computer 44 and then transfer the desired digital audio files to the massager 10 using methods that are commonly known in the art and briefly described above. The downloaded and/or transferred files would be stored in the massager's memory 32 and thereby available for playback by the controller 34. See FIG. 3. The controller 34 is then used for controlling operations of the digital audio playing portion 30 of the massager 10 and the digital audio files received through the external connector 19. The digital audio playing portion 30 of the massager 10 contains a decoder 18 for converting the digital audio files stored in the memory 32 into analog audio signals for output to an audio output port 23 or speaker 27 as well as providing information such as file or track name and battery life to the display 25.

Power to the massager 10 may be supplied either by batteries (rechargeable or standard) or by adapted AC power for the massager 10. Battery power generally delivers more portability to the massager 10. However, AC power may deliver longer and more continuous use of the massager 10 without the depletion suffered by batteries. Further, referring to FIG. 4, users may also connect the external connector (USB connector) 19 of the massager 10, or, as shown in FIG. 5, through a separate charging stand 40, into the USB port 42 of a computer 44 and the computer can provide its power source to the massager 10. In the case of the separate charger 40 (FIG. 5), the charger may also utilize AC power to power the massager or recharge the massager's batteries. In the case of the power generated through the external connector 19 connection to the computer 44, power is then provided to the massager 10 so as to allow the user to use the computer 44 and the massager 10 at the same time. Since the USB interface of a computer is well known, the superfluous description is omitted herein.

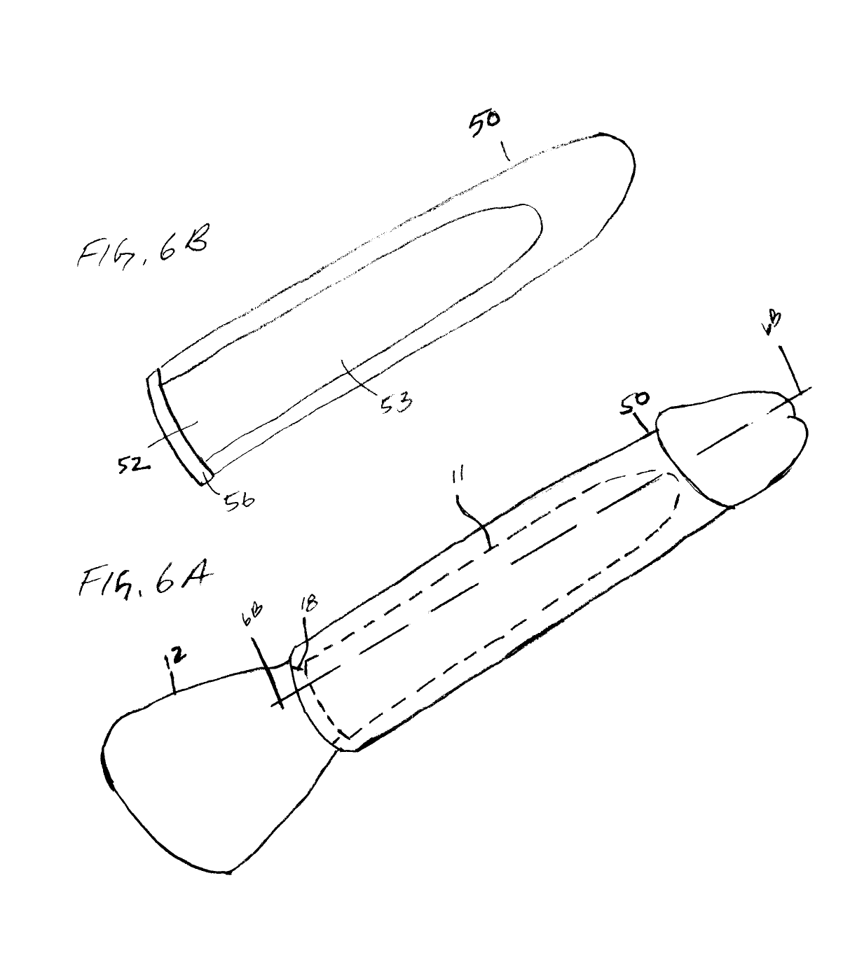

Referring to FIGS. 6A and 6B, an additional embodiment of the massager 10 is shown. In this embodiment, the massager 10 includes a sheath 50 that mateably attaches to the upper body 11. The sheath 50 is attached by sliding it over the upper body 11. The sheath 50 has a bore 52 with an internal surface 53 that mates substantially with the exterior surface of the upper body 11 when the sheath is attached such that the vibrations of the massager are substantially transferred to the sheath 50 and felt by the user.

When the sheath 50 is properly attached, a circumferential ridge 56 located at the base 54 of the sheath 50 is mateably received by the circumferential groove 18 located at the base 16 of the upper body 11, such that the sheath 50 is securely held in place upon the massager 10 during use. However, due to the flexible nature of the sheath 50, it can also be removed by the user by forcing the circumferential ridge 56 from the circumferential groove 18 and the user then pulling the sheath 50 off. It may also be beneficial to have a channel (not shown) that runs the length of the internal surface 53 of the sheath 50 to allow air to escape when the sheath is removed from the driver 10 thereby preventing a potential vacuum.

An attachable and removable sheath 50 allows the user to select the shape, size, texture, material, and color so that the massager can be personalized to a user's preferences. The sheath 50 can be made of a flexible material such as rubber, latex, silicon, or any other similar material.

Although the present disclosure has been described hereinabove by way of preferred embodiments thereof, it can be modified, without departing from the spirit and nature of the disclosure.

What is claimed is:

1. A massager with digital audio player comprising:
an upper body;
a lower body;
said lower body comprising a digital audio player comprising a controller for controlling said digital audio player, external connecting means for connecting said massager to a computer such that digital audio files can be transferred to said massager, storage means for storing said digital audio files transferred to said massager, decoding means to convert said digital files to analog files, operator means for responding to operator commands; and audio output means to output the analog audio signals.

2. The massager of claim 1 further comprising vibration means with a speed control apparatus housed in said lower body.

3. The massager of claim 2 further comprising a display on said lower body.

4. The massager of claim 3 further comprising a sheath for attachment to said upper body of said massager wherein the massager includes a sheath attachment means located between said lower and upper body for attachment of said sheath.

5. The massager of claim 4 wherein the sheath attachment means is a circumferential groove for mateable attachment of a sheath with a circumferential ridge.

6. The massager of claim 3 wherein the external connecting means for connecting said massager to a computer is a USB port.

7. The massager of claim 6 wherein the digital files transferred and decoded by said decoding means are in an MP3 format.

8. The massager of claim 7 wherein the power to operate the massager is selected from the group consisting of batteries, rechargeable batteries, AC power, or power generated by computer through the USB port

9. A massager with digital audio player comprising:
an upper body;
a lower body;
said lower body comprising a digital audio player comprising a controller for controlling said digital audio player, external connecting means for connecting said massager to a computer such that digital audio files can be transferred to said massager, storage means for storing said digital audio files transferred to said massager, decoding means to convert said digital files to analog files; and,
a remote comprising operator means for responding to operator commands; and audio output means to output the analog audio signals.

10. The massager of claim 9 further comprising vibration means with a speed control apparatus housed in said remote.

11. The massager of claim 10 further comprising a display on said remote.

12. The massager of claim 11 further comprising a sheath for attachment to said upper body of said massager wherein the massager includes a sheath attachment means located between said lower and upper body for attachment of said sheath.

13. The massager of claim 12 wherein the sheath attachment means is a circumferential groove for mateable attachment of a sheath with a circumferential ridge.

14. The massager of claim 11 wherein the external connecting means for connecting said massager to a computer is a USB port.

15. The massager of claim 14 wherein the digital files transferred and decoded by said decoding means are in an MP3 format.

16. The massager of claim 15 wherein the power to operate the massager is selected from the group consisting of batteries, rechargeable batteries, AC power, or power generated by computer through the USB port.

17. A method of using a massager with digital audio player capabilities comprising:
connecting a massager to a computer using an external connector;
transferring the selected digital audio files to memory located in said massager;
storing the selected digital audio files in memory located in said massager;
converting the digital audio files to analog files;
outputting the analog files to audio output means so that the user can hear the selected audio files; and,
controlling the operation of the massager and audio files selected.

18. The method of claim 17 wherein the digital audio files are transferred from a computer hard drive.

19. The method of claim 18 wherein the digital audio files are transferred from a compact disk.

20. The method of claim 19 wherein the digital audio files are transferred from a website.
